(19) United States
(12) Patent Application Publication
(10) Pub. No.: US 2008/0072676 A1
(43) Pub. Date: Mar. 27, 2008

(54) Vibration sensor

(76) Inventor: Chen-Fu Peng, Jhonghe City (TW)

Correspondence Address: TROXELL LAW OFFICE PLLC, SUITE 1404, 5205 LEESBURG PIKE, FALLS CHURCH, VA, 22041, US

(21) Appl. No.: 11/526,235

(22) Filed: Sep. 25, 2006

(51) Int. Cl. G01H 11/00

(52) U.S. Cl. 73/649

(57) ABSTRACT

A vibration sensor includes a housing and elastic metal member; the elastic metal member traveling in an accommodation space of the housing while simultaneously contracting or not contacting two contact plates; the vibration sensor being connected at where between a source device and an electronic device; an external force is applied to hit the elastic metal member for it to travel and contact both contact plates to transmit the power from the source device to the electronic device.

### BACKGROUND OF THE INVENTION

(a) Field of the Invention

The present invention is related to a vibration sensor, and more particularly to one that allows source device and electronic device (e.g., light source or loudspeaker) connected to the vibration sensor to execute optional on or off and create intermittent conduction.

(b) Description of the Prior Art

Referring to FIGS. 1 and 2 of the accompanying drawings, a ball vibration switch 1 of the prior art contains a ball 12 that is left free to roll around in a tube 11 with one end closed; two conduction pins 13, 14 are disposed at the free end of the tube 11 with both upper ends respectively of both conduction pins 13, 14 extending into the tube 11 while allowing the ball to contact and conduct through both conduction pins 13, 14 at the same time. Therefore, any external vibration causes the ball 12 to jolt, both conduction pins 13, 14 indicate On or Off status thus to provide the control signals and execute the necessary control with the electronic device.

However, in practical application the prior art is found with the following limitations and deficiencies:

1. Whereas the ball 12 is contained in the cylindrical tube 11 and only two contact plates are disposed at the lower end of the tube 11, usually, the tube 11 must be vertically erected; otherwise any excessive tilt will cause the ball 12 to fail contacting both conduction pins 13, 14, and further to fail the vibration sense effects.

2. Even the installation of the tube 11 is allowed for a certain range of inclination, vibration sense effects exist. However, when the tube 11 is mounted at a certain inclination, the central gravity ball 12 inside the tube 11 has to lean to one side resulting in significant decrease of the sensitivity of vibration induction, and frequent malfunctioning. Therefore, to prevent from compromising the vibration sensitivity and avoid malfunction, the allowed mounting angle is limited to a very narrow range, meaning the mounting location and angle of the tube 11 are subject to extremely great limitation.

3. Since the ball 12 contracts only both conduction pins 13, 14, the resultant On or Off effects vary as the direction of producing the vibration differs, thus to fail the purpose of constant contact.

4. On or Off status is indicated by having the ball 12 to contact both conduction pins 13, 14. Even though the electronic device is always in Off status as long as the vibration switch 1 is not operating, the vibration switch 1 operates only when the circuit is kept under uninterrupted status. Furthermore, the ball 12 can be easily touched to roll around in the course of transportation or display for sales of the vibration switch 1 to result in early consumption of the cell. Accordingly, the vibration switch 1 fails to provide the light emitting results as expected in due time.

### SUMMARY OF THE INVENTION

The primary purpose of the present invention is to provide a vibration sensor that allows a source device and an electronic device (e.g., light source or loudspeaker) connected to it to execute turning on or off the source device by the force of vibration from knocking externally applied to create intermittent conduction while the electronic device is activated when the source device is turned on.

To achieve the purpose, a vibration sensor of the present invention includes a housing and an elastic metal member. The elastic member travels in an accommodation space of the housing while simultaneously contracting or not contacting two contact plates, and the vibration sensor is located at where between and connected to a source device and an electronic device. An external force is applied to hit the elastic metal member for it to travel and contact both contact plates to transmit the power from the source device to the electronic device.

### BRIEF DESCRIPTION OF THE DRAWINGS

FIG. 1 is an exploded view of a vibration switch of the prior art.

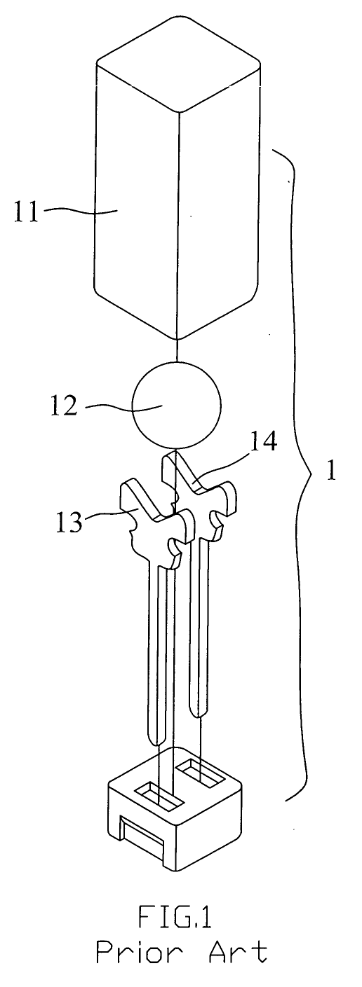

FIG. 2 is a schematic view showing a construction of the vibration switch of the prior art.

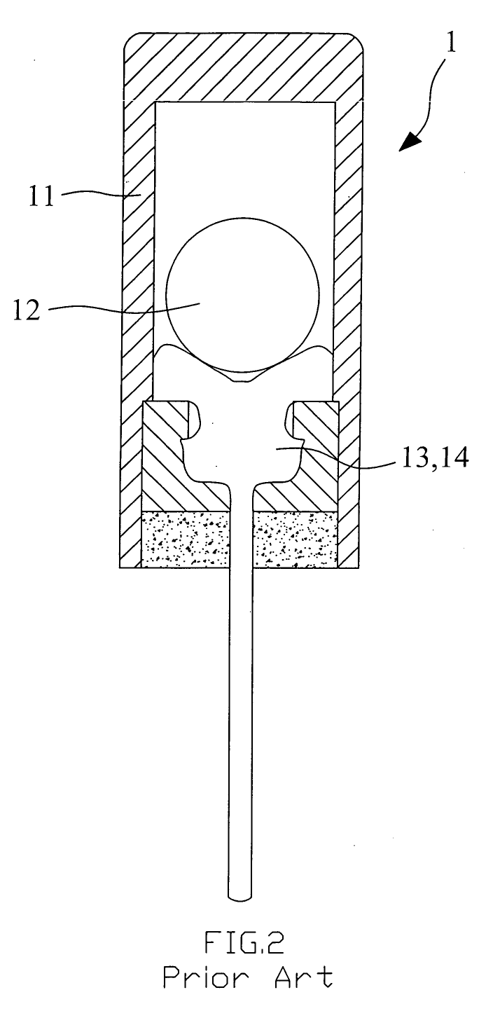

FIG. 3 is a schematic view showing a construction of a vibration sensor of a first preferred embodiment of the present invention.

FIG. 4 is a schematic view showing that a construction of the vibration sensor of the first preferred embodiment of the present invention is electrically conducted.

FIG. 5 is a schematic view showing an operating status of the vibration sensor of the first preferred embodiment of the present invention.

FIG. 6 is an exploded view of a vibration switch of a second preferred embodiment of the present invention.

FIG. 7 is a schematic view showing a construction of a vibration sensor of the second preferred embodiment of the present invention.

FIG. 8 is a perspective view of the second preferred embodiment of the present invention.

FIG. 9 is a schematic view showing that a construction of the vibration sensor of the second preferred embodiment of the present invention is electrically conducted.

FIG. 10 is schematic view showing that the circuit of the vibration sensor of the second preferred embodiment is in off statue.

FIG. 11 is a perspective view showing that the vibration sensor of the second preferred embodiment of the present invention is applied in a piece of shoes.

FIG. 12 is a perspective view showing that the vibration sensor of the second preferred embodiment of the present invention is applied in a cap.

FIG. 13 is a schematic view showing a third preferred embodiment of the present invention.

### DETAILED DESCRIPTION OF THE PREFERRED EMBODIMENTS

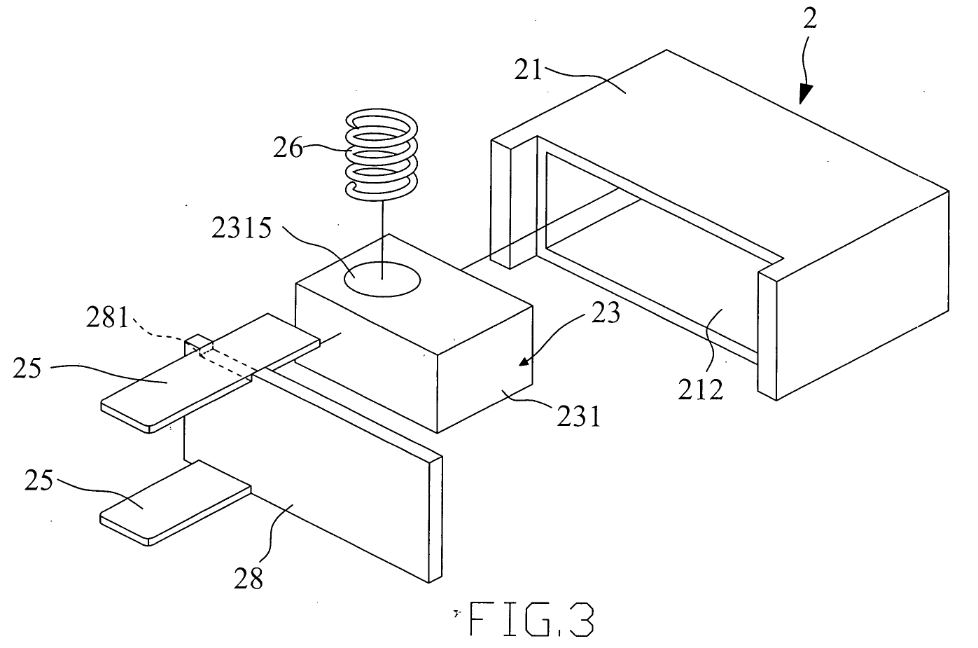

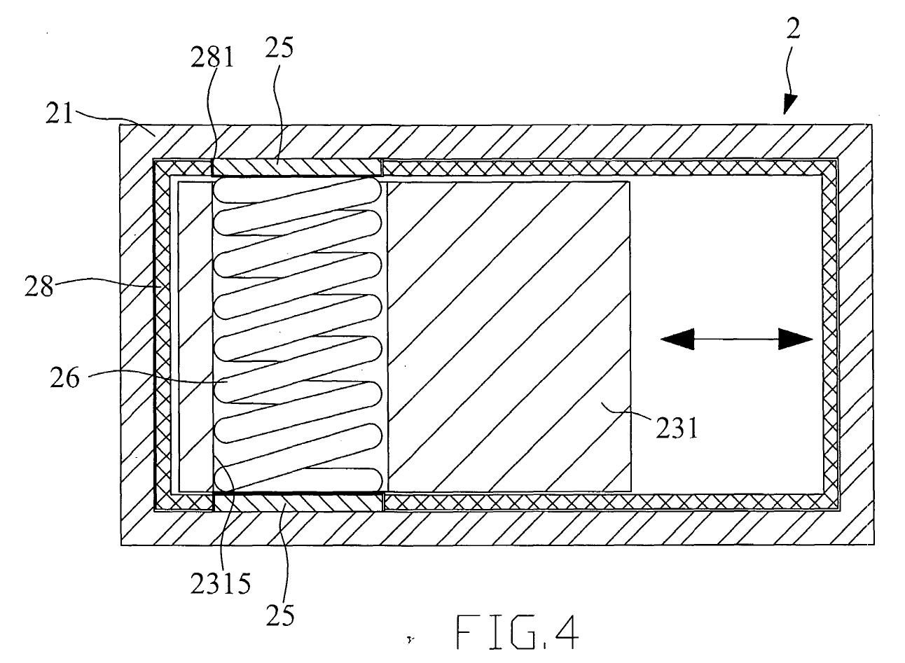

Referring to FIGS. 3 and 4, a vibration sensor 2 of the present invention includes a housing 21 and an elastic metal member 23. The housing contains an accommodation space 212; two contact plates 25 are respectively disposed on two opposite sides of the housing 21. Each contact plate 25 of the preferred embodiment as illustrated is inserted in a locating trough 281 preset on a plate 28 to be secured to one side of the accommodation space 212 by means of the plate 28 while allowing one end of the conduction plate 25 to extend into the accommodation space 21 and another end exposed out of the housing 21.

The elastic metal member 23 received and traveling in the accommodation space 212 includes a load 231, and the load 231 is disposed with a locating hole 2315 to accommodate an elastic member 26 (e.g., a coil).

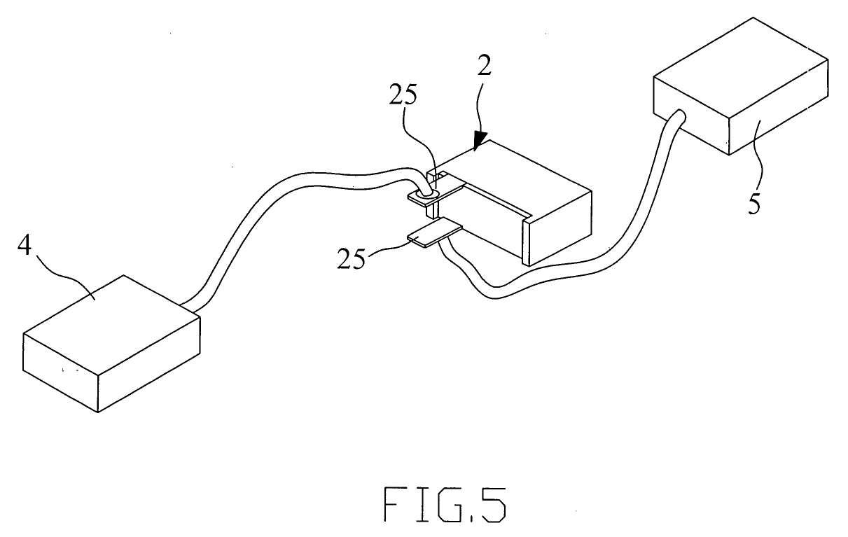

The vibration sensor 2 is connected to a source device 4 (e.g., a cell) and an electronic device 5 (e.g., a light source or loudspeaker) as illustrated in FIGS. 3 and 5. The elastic metal member 23 is located in the accommodation space 212 on the other side opposite to where two conduction plates 25 are provided so that it will not contact both conductor plates 25 at the same time. Accordingly, as long as both conductors are situated in the disconnected status, there will be no power to be transmitted from the source device 4 connected to one end of the conductor plates 25 to the electronic device 5 connected to the other end of the conductor plate 25.

When the elastic metal member 23 travels due to the housing hit or knock on any other object as illustrated in FIG. 4, the elastic metal member 23 contacts both conductor plates 25 at the same time to conduct through them for the power from the source device to be delivered to the electronic device.

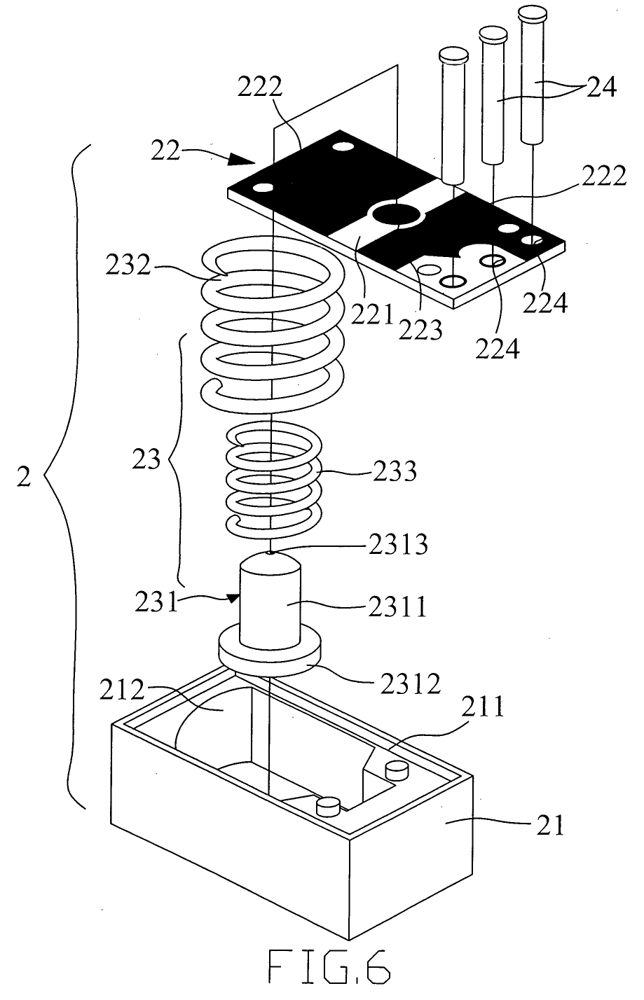

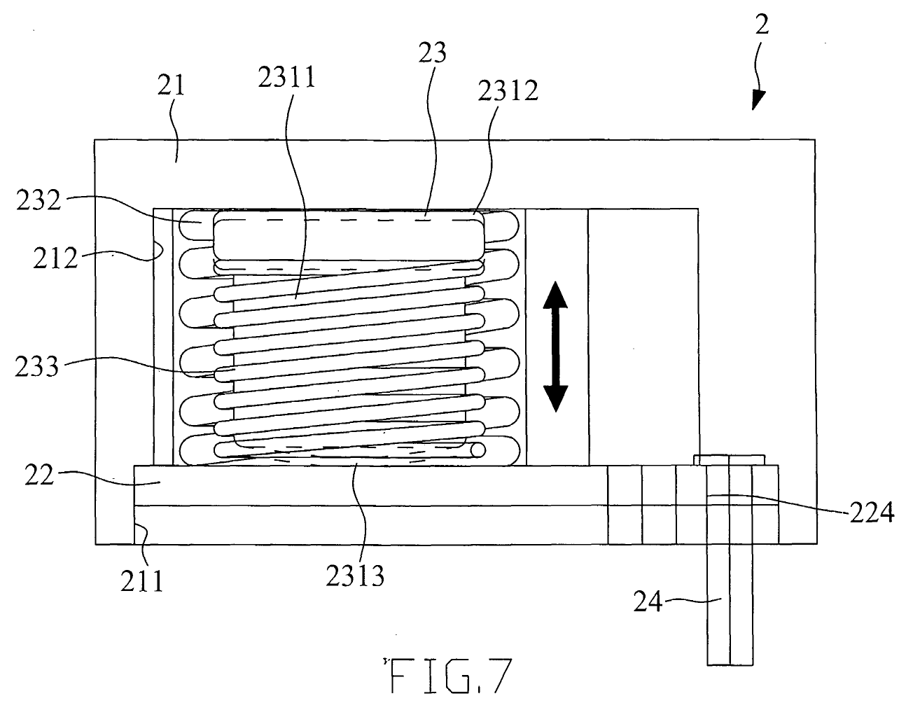

In another preferred embodiment of the present invention as illustrated in FIGS. 6 and 7, the vibration sensor 2 includes the housing 21, a substrate 22, and an elastic metal member 23. An opening 211 is disposed on one side of the housing 21 and screened with a substrate 22 while the accommodation 212 is defined inside the housing 21. The substrate 22 related to a circuit board has provided on it surface a buffer zone 221 to separate two electrode areas 222. A vibration contact 223 separately from both electrode areas 222 is disposed on the buffer zone 221. A transmission contact is disposed on either electrode area 222 and the transmission contact is made in a form of three holes 224 as illustrated.

The elastic metal member 23 received in the accommodation space 212 is disposed with a load 231, an outer coil 232 and an inner coil 233. The load 231 includes a column 2311 and a flange 2312 disposed at the lower end of the column 2311, and a nipple 2312 to contact the substrate 22 on the distal end from the flange 2312. The inner diameter of the outer coil 232 is slightly greater than that of the flange 2313 for the outer coil 232 to merely be inserted onto the circumference of the flange 2313. Meanwhile, the inner diameter of the inner coil 232 is slightly greater than that of the column 2311 for the inner coil 233 to be merely inserted onto the outer circumference of the column 231 and held against by the flange 2312.

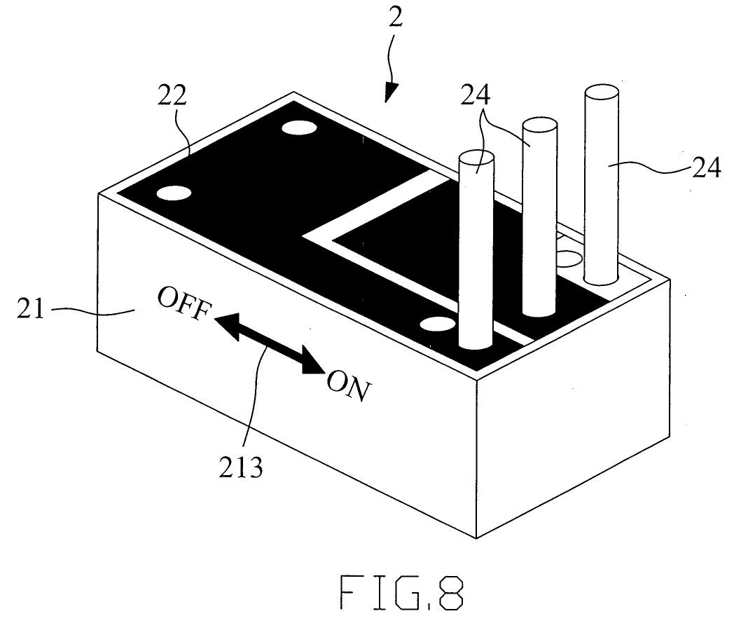

Upon assembling, the load 231 is placed in the accommodation space 21 with its flange 2312 heading for the bottom of the accommodation space 212. Both of the outer coil 232 and the inner coil 233 are respectively inserted to the outer sides of the flange 2312 and the column 2311. A conduction column 24 penetrates through the hole 224 disposed on the substrate 22 to tightly contract each other before having the substrate 22 to cover upon the opening 211 of the housing 21 to complete the assembly as illustrated in FIG. 8. Each conduction column 24 is exposed out of the housing 21 for a certain length for circuit connection.

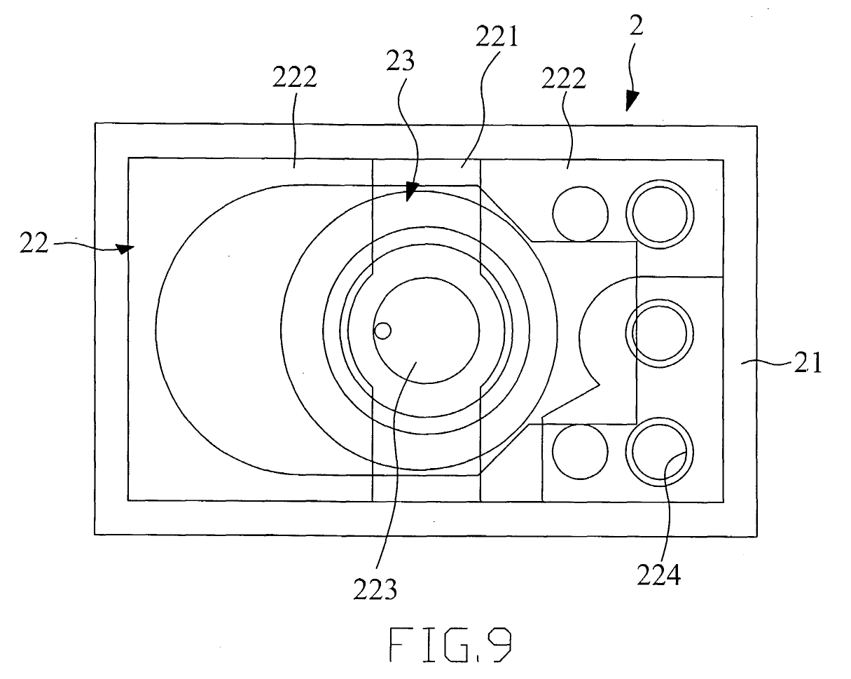

As illustrated in FIG. 9, the elastic metal member 23 travels inside the housing to result in displacement on the substrate 22 when the vibration sensor hits or knocks on any other object for the elastic metal member to contact both electrode areas 222 at the same time thus to conduct through the source device and the electronic device for the power from the former to be delivered to the latter.

Now referring to FIG. 7, with the source turned on, the user by causing longitudinal vibration for the load 231 and the inner coil to contact the vibration contact 223 thus for the electronic device to operate by creating conduction of intermittent vibration.

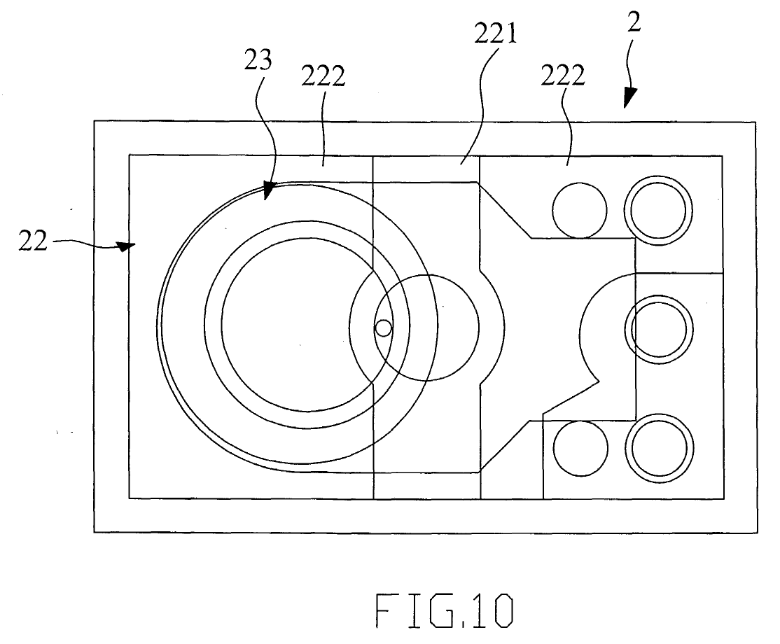

To break the circuit between the source device and the electronic device, the elastic metal member 23 is cause to have lateral movement on the substrate 22 to prevent the elastic metal member 23 from contacting both electrode areas at the same time as illustrated in FIG. 10. In the disconnected status, the source device does not supply power to the electronic device and the source is in off status. At this time, the electronic device is inoperative in the absence of power supply even the vibration sensor detects the force of longitudinal vibration.

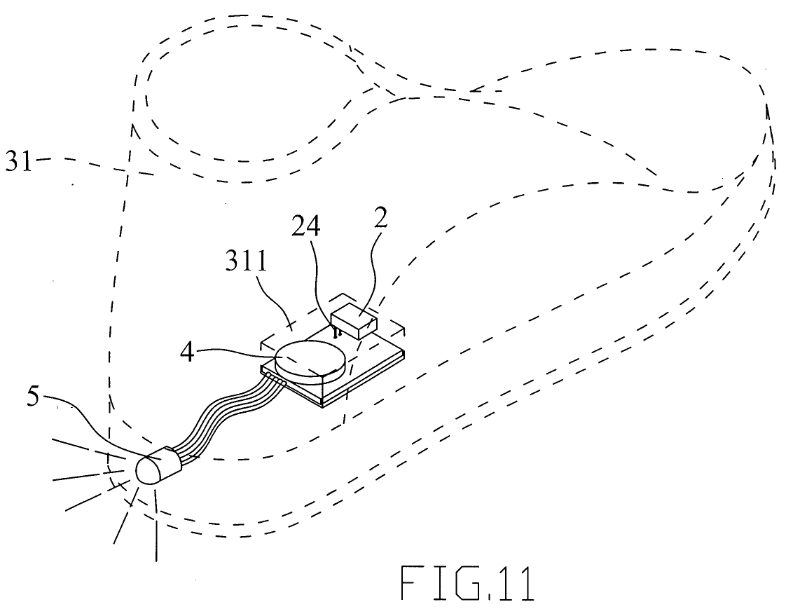

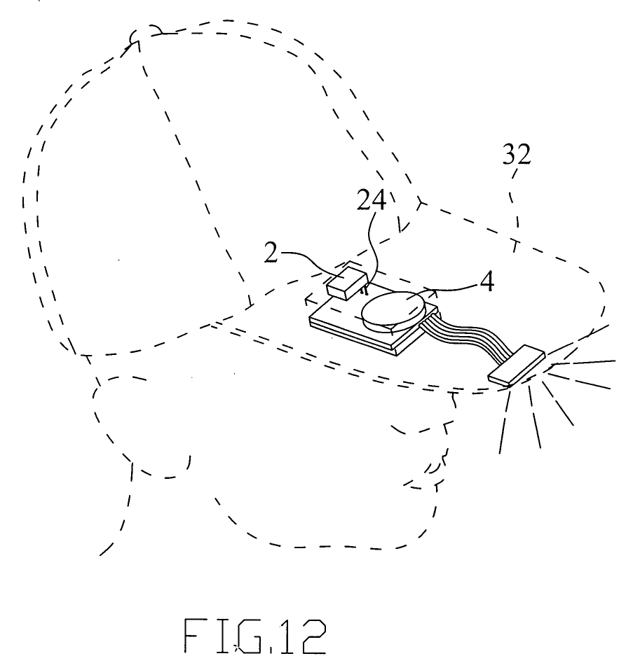

In practice, the vibration sensor 2 is mounted in a shoe 31 as illustrated in FIG. 11. An accommodation trough 311 is provided inside the shoe 31 to accommodate the vibration sensor 2. Of course, the vibration sensor 2 may be mounted in other object such as a cap as illustrated in FIG. 12 or a piece of clothes. Multiple conduction columns 24 and circuit are connected to the source device 4, the vibration sensor 2, and the electronic device 5 and the electronic device creates intermittent conduction by turning on or off the source device 4 through the vibration sensor 2.

As illustrated in FIGS. 11 and 12, the source device is related to a cell and the electronic device 5 is related to a light source or a loudspeaker. By selecting to turn on or off the source device with the vibration sensor 2 the power from the source device is delivered to the electronic device 5 while the electronic device creates intermittent conduction by vibration through the vibration sensor 2 thus for the electronic device to produce light or sound. The light source may be related to a light-emitting device or may be comprised of one or a plurality of single color or multi-color light source to crate effects of colorful light source.

It is to be noted that during the object is in the course of transportation or display for sales, the electronic device is disconnected form the source device by operating the elastic metal member. Accordingly, the electronic device cannot be conducted through even the vibration sensor is contacted and conducted through to avoid unnecessary power consumption.

As illustrated in FIG. 8, a on-off marker 213 is provided to the outer side of the housing to indicate the conduction direction of the source device thus to guide the user to follow the direction as indicated by the marker 213 for the housing to hit or knock on any other object to remove the elastic metal member. When the elastic metal member is moved towards the On direction as indicated by the marker 213, both of the source device and the electronic device are conducted through. The user is then causing vibration for the electronic device to create intermittent conduction by vibration.

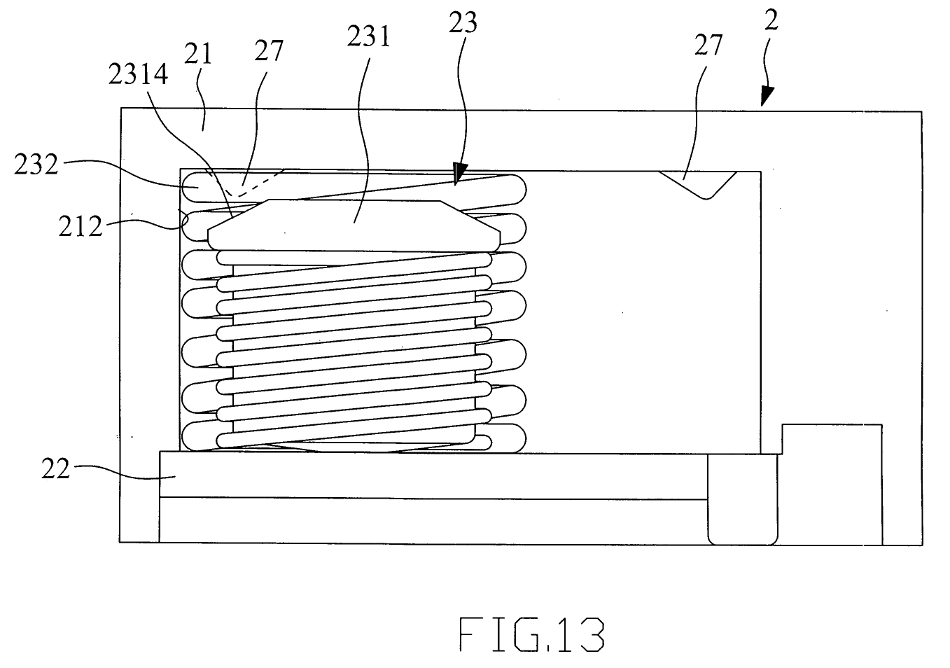

Furthermore, as illustrated in FIG. 13, a limiting wedge 27 is disposed in the accommodation space 21 of the housing 21 at where in relation to one side of the substrate 22. An bevel edge 2314 is disposed over the load 231 so that when the elastic metal member excises lateral movement in the accommodation space 212 to conduct through both of the source device and the electronic device, the outer coil 232 at the outer edge of the 231 is retained by the limiting wedge 27 to refrain from easy lateral movement thus to ensure that the source is kept in On status without being affected by the longitudinal vibration.

The prevent invention provides a structure of a vibration sensor that is more feasible to be applied in an object, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A vibration sensor includes a housing containing an accommodation space and two contact plates respectively disposed on both sides on the housing with the surfaces of both contact plates respectively exposed from the housing and in the accommodation space; and an elastic metal member received and traveling in the accommodation space for simultaneously contacting or not contacting both contact plates to conduct or disconnect both contact plates.

2. The vibration sensor as claimed in claim 1, wherein the elastic metal member includes a load and a set of elastic device inserted on the load.

3. The vibration sensor as claimed in claim 1, wherein both contact plates are respectively connected to a source device and an electronic device to transmit the power to the electronic device from the source device when both contact plates are conducted through.

4. A vibration sensor includes a housing containing an accommodation space and disposed with an opening screened with a substrate on one side of the housing; the substrate provided on its surface two electrode areas separating from each other by a buffer zone, a vibration contact being disposed on the buffer zone that is separated from both electrode areas, an elastic metal member disposed in the accommodation space and traveling on the substrate to simultaneously contact or not contact both electrode areas and execute conduction or disconnection of the vibration contact; and a transmission contact connected to the source device, substrate and the electronic device to optionally deliver power from the source device to the electronic device while causing the electronic device to create intermittent conduction through by means of the vibration contact.

5. The vibration sensor as claimed in claim 4, wherein the elastic metal member includes a load, an outer coil and an inner coil; the load being made in a form of a column and a flange at its bottom; and a nipple to contact the substrate being disposed the column at its distal side from the flange.

6. The vibration sensor as claimed in claim 5, wherein the inner diameter of the outer coil is slightly greater than that of the flange for the outer coil to merely insert onto the outer circumference of the flange.

7. The vibration sensor as claimed in claim 5, wherein the outer coil is slightly longer than the height of the accommodation space.

8. The vibration sensor as claimed in claim 5, wherein the inner diameter of the inner coil is slightly greater than that of the column for the inner coil to merely insert onto the outer circumference of column.

9. The vibration sensor as claimed in claim 4, wherein the substrate is related to a circuit board.

10. The vibration sensor as claimed in claim 4, wherein the transmission contact related to a hole on the substrate; a conduction column being inserted into the hole; and the circuit is connected to the conduction column and where between the source device and the electronic device.

11. The vibration sensor as claimed in claim 4, wherein the source device related to a cell.

12. The vibration sensor as claimed in claim 4, wherein the electronic device relates to a light source or a loudspeaker.

13. The vibration sensor as claimed in claim 12, wherein the light source is comprised or one or a plurality of single color or multiple-color light emitting device.

14. The vibration sensor as claimed in claim 4, wherein the vibration sensor is mounted in an object; and the object contains an accommodation trough to accommodate the vibration sensor.

15. The vibration sensor as claimed in claim 4, wherein a limiting wedge is disposed in the accommodation space of the housing.

16. The vibration sensor as claimed in claim 4, wherein the limiting wedge is disposed on one side of the substrate in opposite to the housing.

17. The vibration sensor as claimed in claim 16, wherein the limiting wedge is disposed in the housing on the side opposite to the substrate
